(19) United States
(12) Patent Application Publication
(10) Pub. No.: US 2020/0298693 A1
(43) Pub. Date: Sep. 24, 2020

(54) System, Method, and Apparatus for Flood Damage Avoidance

(71) Applicant: Jonathan Hoffman, Bradenton, FL (US)

(72) Inventor: Jonathan Hoffman, Bradenton, FL (US)

(21) Appl. No.: 16/361,268

(22) Filed: Mar. 22, 2019

(51) Int. Cl. B60J 11/04; B65D 85/68; B65D 88/16; B65D 88/54

(52) U.S. Cl. CPC B60J 11/04; B65D 85/68; B65D 2581/02; B65D 88/548; B65D 2585/6867; B65D 88/1606

(57) ABSTRACT

An apparatus for reducing a probability of damage to a vehicle from rising water includes a first sheet of a water-resistant material and a second sheet of the water-resistant material. A first side of a connector (e.g., zipper) is interfaced to a first periphery of the first sheet of the water-resistant material and a second side of the connector is interfaced to a second periphery of the second sheet of the water-resistant material. After a vehicle is placed upon the first sheet of the water-resistant material, the second sheet of the water-resistant material is draped over the vehicle and the first side connector is engaged with the second side connector, thereby encapsulating the vehicle within the first sheet and second sheet of the water-resistant material

### FIELD

This invention relates to the field of vehicles and more particularly to a system for reducing the risk of damage to vehicles from rising water.

### BACKGROUND

Every year various communities are impacted by flooding. Whether from storm surge, excess rain, snow melting, bridge dams in rivers, or anything else, many people have their homes, property, and vehicles destroyed by rising water.

Motor vehicles are of particular concern in this application. After flooding recedes, vehicle buyers must be wary to make sure the vehicle they are purchasing was not flooded. Sometimes, it is difficult to tell, but a musty smell and mud lines in the engine compartment are sure giveaways. A vehicle in which flood water crests above the engine intake is typically considered a total loss from an insurance perspective, but such vehicles are often refurbished and sold as if nothing was wrong.

There are two classifications of flooding. One in which water rises and one in which water flows. Rising water will often damage a vehicle, but will not relocate the vehicle and crash the vehicle into other vehicles, buildings, objects, etc. Flowing water on the other hand has sufficient force to push vehicles many feet or miles, often destroying the vehicle and damaging that which is hit by the vehicle.

There is not much one can do with regard to flowing water, other than relocating the vehicle to an area where flooding isn't expected as is often done before storms having advanced warning (e.g. hurricanes). Rising water is different, in that, the flood waters rise slowly, do their damage to vehicles, then ebb slowly, leaving mud and debris in their wake. Often, those affected are not aware of the rising water until it is too late, not expecting the severity of the situation. Take hurricane Harvey and Katrina, those inland, away from the storm surge, experienced slowly rising flood waters. Some of those that stayed in their homes found themselves surprised and, later, on their roofs hoping for a helicopter or boat to rescue them. In these situations, the last of these people's worries is their vehicles.

In countless rising flood water situations, the water rises 1-3 feet, then recedes, often not high enough to damage homes that are higher than street level or on stilts, but vehicles on the street are subject to damage from these intermediate floods.

What is needed is a system that will reduce the possibility of water intrusion to vehicles that are subject to rising flood waters.

### SUMMARY

A system, method, and apparatus for flood damage avoidance provides some level of protection for certain flooding conditions, typically minimally flowing flood water conditions. In such, vehicles (e.g. cars, vans, trucks, motorcycles, golf cards) are subjected to rising flood water, but are typically not swept away by strong currents. In such, the flood water rises slowly, but often rises high enough as to enter passenger compartments, engine compartments, storage/trunks, etc., causing substantial damage to the vehicles. The disclosed apparatus provides a shield of protection to vehicles in certain levels of low-flowing flood water, providing a partial encapsulation of the vehicle to reduce chances of flood water penetration into the vehicles.

In one embodiment, a system for mitigating vehicular flood damage is disclosed including at least one sheet of a water-resistant material and a device for closing the at least one sheet of the water-resistant material. A vehicle standing upon the at least one sheet of the water-resistant material is substantially enclosed within the sheet of the water-resistant material upon operating the device for closing, thereby, a potential of damage from rising flood water is reduced by the at least one sheet of the water-resistant material.

In another embodiment, a method of reducing a probability of damage to a vehicle caused by rising water is disclosed including positioning the vehicle atop a sheet of a water-resistant material and enclosing at least part of the vehicle in the sheet of the water-resistant material, thereby reducing water penetration into the sheet of the water-resistant material caused by rising water.

In another embodiment, an apparatus for reducing a probability of damage to a vehicle from rising water is disclosed including a first sheet of a water-resistant material and a second sheet of the water-resistant material. A first side of a connector (e.g., zipper) is interfaced to a first periphery of the first sheet of the water-resistant material and a second side of the connector is interfaced to a second periphery of the second sheet of the water-resistant material. After a vehicle is placed upon the first sheet of the water-resistant material, the second sheet of the water-resistant material is draped over the vehicle and the first side connector is engaged with the second side connector, thereby encapsulating the vehicle within the first sheet and second sheet of the water-resistant material.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an elevational view of a vehicle ready for installation of the flood damage mitigation system.

FIG. 2 illustrates an elevational view of a vehicle with the flood damage mitigation system installed.

FIG. 3 illustrates a plan view of a vehicle ready for installation of the flood damage mitigation system.

FIG. 4 illustrates an elevational view of a vehicle ready for installation of an alternate embodiment of the flood damage mitigation system.

FIG. 5 illustrates an elevational view of a vehicle with the alternate embodiment of the flood damage mitigation system installed.

FIG. 6 illustrates an elevational view of a vehicle with the flood damage mitigation system installed utilizing optional tie-downs.

FIG. 7 illustrates an elevational view of a vehicle with the alternate embodiment of the flood damage mitigation system installed utilizing the optional tie-downs.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

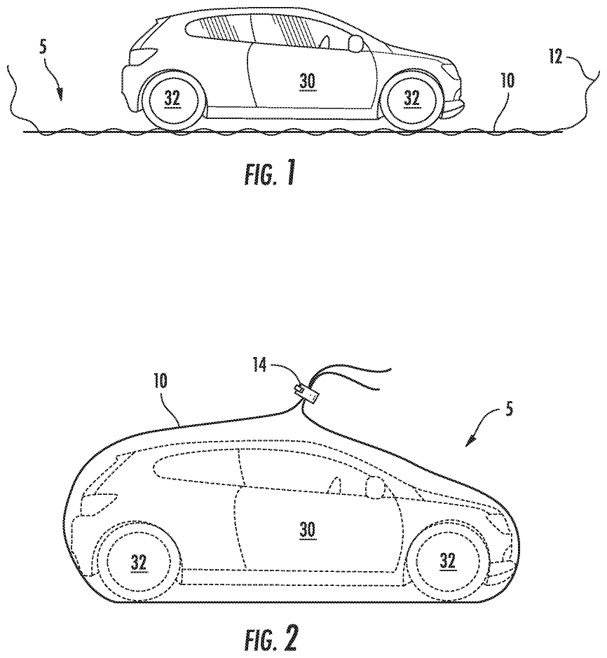

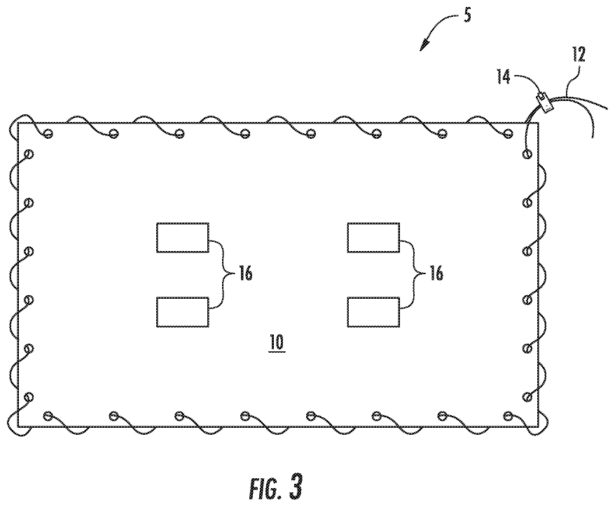

Referring to FIGS. 1 and 2, elevational views of a vehicle 30 ready for installation and after installation of the flood damage mitigation system 5 are shown. Nothing will protect a vehicle 30 from all floods, but some floods present high water that comes and goes without sufficient force to substantially relocate a vehicle 30. If such flood waters only rise a few inches, little vehicle damage, if any, occurs. When such flood waters rise between, for example, one and three feet, many vehicles 30 are damaged by water intrusion into the passenger compartment, engine compartment, trunk, etc. The flood damage mitigation system 5 shown in FIGS. 1 and 2 reduce the chances of damage to the vehicle 30 due to such rising flood water (and debris, mud, etc.).

The flood damage mitigation system 5 includes a sheet of water-resistant material 10, a device for closing 12 the sheet of water-resistant material 10, and a device for fastening 14 (or tying) the device for closing 12. Before there is a prediction of a flood (or before going on vacation, etc.), the vehicle 30 that is to be protected is positioned on the sheet of water-resistant material 10 and the device for fastening 14 is engaged while edges of the sheet of water-resistant material 10 are lifted until the vehicle 30 is substantially enclosed within the sheet of water-resistant material 10, at which time the device for fastening 14 is utilized to maintain such enclosure (or ends of the device for fastening 14 is tied). In such, later, as flood waters rise, the vehicle 30 is protected from most or all of the flood waters.

It is anticipated that the sheet of water-resistant material be made of a durable cloth (e.g. canvas) or flexible plastic, or combination of such as often used in the tarp industry. A water-proof material would be best, but water-resistant material is sufficient, as most flood waters recede within a few days and a small intrusion of flood water (e.g. a few inches) will likely not harm the vehicle 30. Likewise, if there is an imperfect closure by the device for fastening 14, small amounts of rainwater entering the flood damage mitigation system 5 will likely not damage the vehicle 30.

In the example shown, the device for fastening 14 is a spring clip through which ends of the device for closing 12 pass. Squeezing of the spring clip allows for pulling of the device for closing 12 through the spring clip, while releasing of the spring clip holds tight the ends of the device for closing 12. It is fully anticipated that other fastening devices be used for the device for fastening 14, including a simple knot system.

Referring to FIG. 3 illustrates a plan view of the flood damage mitigation system 5. In this, the sheet of water-resistant material 10 is shown laid out on a pavement (not shown). The device for closing 12 the sheet of water-resistant material 10 is shown passing through eyelets in the sheet of water-resistant material 10, on all edges, meeting at one corner where the device for fastening 14 (or tying) the device for closing 12 is found. In some embodiments, markings 16 are provided, in this example, markings 16 for positioning tires of the vehicle 30, though in other examples, the markings are visible to a driver as the driver moves the vehicle 30 upon the sheet of water-resistant material 10. In the example shown, the markings 16 provide a gauge as to where the driver should align the wheels 32 of the vehicle 30 before enclosing the vehicle 30 in the flood damage mitigation system 5. Before flood waters rise, the vehicle 30 is moved upon the sheet of water-resistant material 10 and the device for closing 12 (in this case rope or string threaded through eyelets in the sheet of water-resistant material 10) is engaged (e.g. pulled) until the sheet of water-resistant material 10 gathers, preferably above the roof of the vehicle 30, but in any way that will limit the amount of flood water that rises and contacts the vehicle 30. For example, in some usage scenarios for very large vehicles 30, the sheet of water-resistant material 10 gathers mid-way up around the vehicle 30 and the device for closing 12 is tightened sufficiently to hold the sheet of water-resistant material 10 and keep the sheet of water-resistant material from falling as the flood waters rise. Again, it is anticipated that small amounts of harmless rain water will wind up inside the sheet of water-resistant material 10 without damaging the vehicle 30.

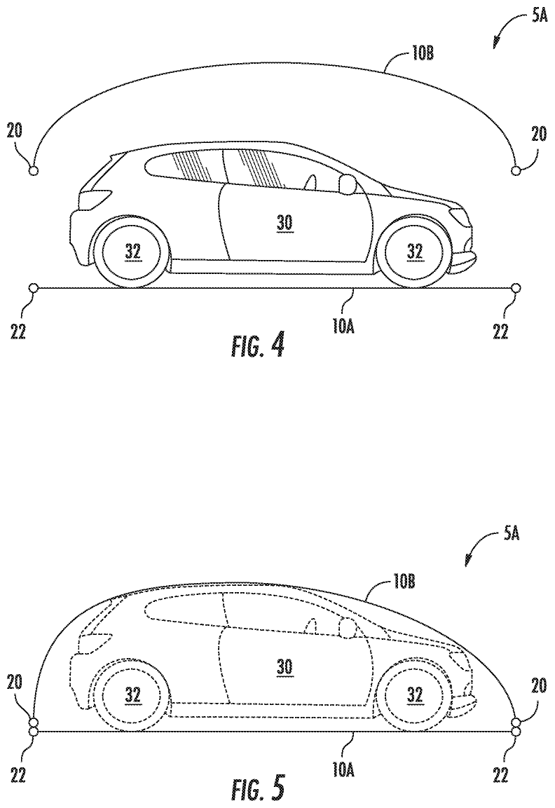

Referring to FIGS. 4 and 5, elevational views of a vehicle ready for installation and after installation of an alternate embodiment 5B of the flood damage mitigation system 5 are shown. In this embodiment, the sheet of water-resistant material 10 is formed in two sections 10A/10B of water-resistant material 10, though as many sections as is practical are anticipated. Each of the two sections 10A/10B of water-resistant material 10 have connectors 20/22 around their respective peripheries, though not necessarily exactly on the edge of each of the sections 10A/1B of water-resistant material 10.

In this example, a first section 10A of water-resistant material 10 is positioned on the ground and the vehicle 30 is moved atop the first section 10A of water-resistant material 10. Next the second section 10B of water-resistant material 10 is draped over the vehicle and the first connector 20 of the second section 10B of the water-resistant material 10 is engaged with the second connector 22 of the first section 10A of water-resistant material 10, thereby sealing or substantially sealing the first section 10A of water-resistant material 10 to the second section 10B of the water-resistant material 10. Note that there is no limitation as to the location at which the second section 10B of the water-resistant material 10 is engaged with the second connector 22 of the first section 10A of water-resistant material 10. Even though the location of engagement shown in FIG. 5 is at ground level, any location of engagement is anticipated such as mid-way between ground level and the roof level of the vehicle 30 or at the roof level of the vehicle 30.

Although any type of connectors 20/22 are anticipated including snaps, plastic zippers; one preferred type of connectors 20/22 are zippers. Many zippers are somewhat water resistant, though as stated above, it is anticipated that small amounts of flood water will leak into the joined sections 10A/10B of the water-resistant material 10.

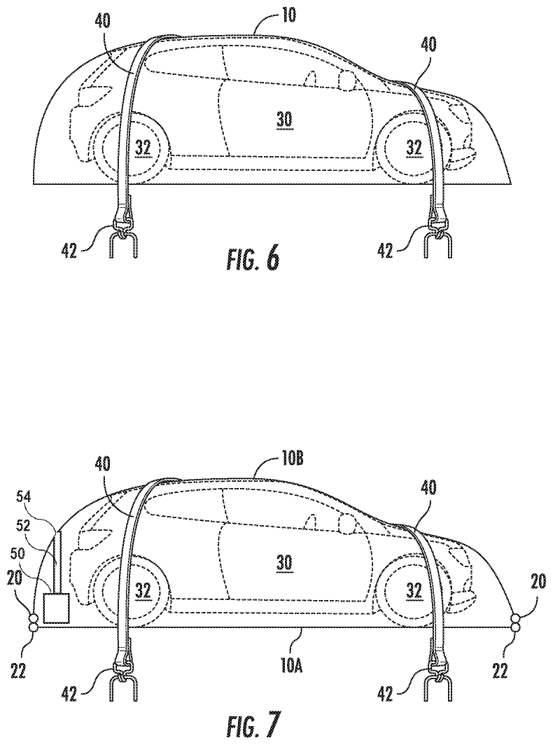

Referring to FIGS. 6 and 7, elevational views of a vehicle 30 with a flood damage mitigation system 5 installed utilizing optional tie-downs 40 are shown. As it is often true, even though vehicles 30 are often quite heavy, air trapped within the vehicles (e.g. under the hood, in the passenger compartment, in the trunk) displace water and provide lift to the vehicle 30. With such lift, even in relatively still flood water, the vehicle 30 will float and move due to winds and currents, often causing damage to the vehicle 30, other vehicles, property, etc. To reduce the risk of such damage, optional tie-downs 40 are positioned across the sheet of water-resistant material 10 and vehicle 30 contained there within. Ends of the optional tie-downs 40 are anchored to the ground by ground anchors 42. The ground anchors 42 are typically pre-installed into the ground or pavement. The strength of the tie-downs 40 and ground anchors 42 need only counteract the expected buoyancy of the vehicle 30 as flood waters rise, hopefully keeping the vehicle 30 in place until the flood waters recede. In some embodiments, the tie-downs 40 pass through the sheet of water-resistant material 10 (e.g. through water resistant grommets) and hook onto vehicle shipping eyelets to provided a stronger support while reducing the potential for body damage caused by tie down straps running across the body of the vehicle 30.

Also shown in FIG. 7 is a submersible pump 50 that is positioned such that an inlet of the submersible pump 50 is near the first section 10A of the sheets of the water-resistant material 10 (e.g. near the ground) and the submersible pump 50 has an outlet channeled to an output orifice 54 on the second sheet 10B of the water-resistant material 10 through a tube or pipe 52. In this, if flood water seeps into the first sheet 10A of the water-resistant material 10 and the second sheet 10B of the water-resistant material 10 (e.g. through the connector 20/22), the submersible pump 50 will pump such flood water out from between the first sheet 10A of the water-resistant material 10 and the second sheet 10B of the water-resistant material 10. In some embodiments, the submersible pump 50 is powered by a battery. In some embodiments, the submersible pump 50 is powered by a battery of the vehicle 30 (e.g. using a 12V plug or USB plug, as known in the vehicle industry).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A system for mitigating vehicular flood damage, the system comprising:
at least one sheet of a water-resistant material; and
means for closing the at least one sheet of the water-resistant material;
whereas a vehicle standing upon the at least one sheet of the water-resistant material is substantially enclosed within the sheet of the water-resistant material upon operating the means for closing, thereby, a potential of damage from rising flood water is reduced by the at least one sheet of the water-resistant material.

2. The system of claim 1, wherein at least one sheet of the water-resistant material is exactly one sheet of the water-resistant material.

3. The system of claim 1, wherein the at least one sheet of the water-resistant material is two sheets of the water-resistant material.

4. The system of claim 3, wherein each of the two sheets of the water-resistant material has a peripherally located connector that engages with the peripherally located connector of the other of the two sheets of the water-resistant material.

5. The system of claim 1, further comprising means for fastening of the means for closing, the means for fastening holding the at least one sheet of the water-resistant material in a closed position.

6. The system of claim 1, wherein at least one of the at least one sheet of the water-resistant material comprises canvas.

7. The system of claim 1, wherein at least one of the at least one sheet of the water-resistant material comprises a flexible plastic.

8. The system of claim 1, further comprising a submersible pump, the submersible pump configured to pump the flood water out of the at least one sheet of the water-resistant material.

9. A method of reducing a probability of damage to a vehicle caused by rising water, the method comprising:
positioning the vehicle atop a sheet of a water-resistant material; and
enclosing at least part of the vehicle in the sheet of the water-resistant material, thereby reducing water penetration into the sheet of the water-resistant material caused by rising water.

10. The method of claim 9, wherein the step of enclosing includes a step of operating a device for closing, the device for closing interfaced to a peripheral edge of the sheet of the water-resistant material.

11. The method of claim 10, further comprising a step of locking the device for closing using a means for fastening.

12. The method of claim 9, wherein the step of enclosing comprises:
draping a second sheet of the water-resistant material over the vehicle and
connecting a peripheral edge of the sheet of the water-resistant material to a second peripheral edge of the second sheet of the water-resistant material using a connector.

13. The method of claim 12, wherein the connector is a zipper.

14. The method of claim 12, wherein the sheet of the water-resistant material and the second sheet of the water-resistant material are made of a material selected from the group consisting of a canvas material and a flexible plastic material.

15. An apparatus for reducing a probability of damage to a vehicle from rising water, the apparatus comprising:
a first sheet of a water-resistant material;
a second sheet of the water-resistant material;
a first side of a connector interfaced to a first periphery of the first sheet of the water-resistant material; and
a second side of the connector interfaced to a second periphery of the second sheet of the water-resistant material;
whereas after the vehicle is placed upon the first sheet of the water-resistant material, the second sheet of the water-resistant material is draped over the vehicle and the first side connector is engaged with the second side connector, thereby encapsulating the vehicle within the first sheet and second sheet of the water-resistant material.

16. The apparatus of claim 15, wherein at least one of the first sheet of the water-resistant material and the second sheet of the water-resistant material is made from a canvas.

17. The apparatus of claim 15, wherein at least one of the first sheet of the water-resistant material and the second sheet of the water-resistant material is made from a flexible plastic.

18. The apparatus of claim 15, wherein the first side connector is one side of a zipper and the second side connector is a second side of the zipper.

19. The system of claim 2, further comprising at least one tie-down strap affixed to the exactly one sheet of the water-resistant material, a first end of each of the at least one tie-down straps is attached to a first ground anchor on a first side of the vehicle and a second end of each of the at least one tie-down straps is attached to a second ground anchor on a second side of the vehicle.

20. The apparatus of claim 15, further comprising a submersible pump, the submersible pump having an inlet near the first sheet of the water-resistant material and the submersible pump having an outlet channeled to an output orifice on the second sheet of the water-resistant material.
